(19) United States
(12) Patent Application Publication
(10) Pub. No.: US 2020/0173874 A1
(43) Pub. Date: Jun. 4, 2020

(54) METHOD FOR DETECTING ABNORMAL TERMINAL OF CARRIER

(71) Applicant: WUHAN CHINA STAR OPTOELECTRONICS SEMICONDUCTOR DISPLAY TECHNOLOGY CO., LTD., Wuhan, Hubei (CN)

(72) Inventor: Mingjun DONG, Wuhan, Hubei (CN)

(21) Appl. No.: 16/463,159

(22) PCT Filed: Mar. 13, 2019
(86) PCT No.: PCT/CN2019/077963

§ 371 Date: May 22, 2019

(30) Foreign Application Priority Data
Nov. 28, 2018 (CN) 201811430781.2

(51) Int. Cl. G01L 5/00; G01M 13/00

(52) U.S. Cl. CPC G01L 5/0071; G01M 13/00

(57) ABSTRACT

A method for detecting an abnormal terminal of a carrier having annular areas with terminals for carrying a substrate, including placing the substrate on the terminals of the carrier; when the terminals carry the substrate, measuring force values taken by the terminals; and comparing the force values taken by the terminals in a same annular area to detect the abnormal terminal corresponding to each of the annular areas.

### BACKGROUND OF DISCLOSURE

### 1. Field of Disclosure

The present disclosure relates to a technical field of carrying a substrate, and more particularly, to a method for detecting an abnormal terminal of a carrier.

### 2. Description of Related Art

Currently, in preparation for electronic products (such as liquid crystal display panels, semiconductor devices, or solar cells, and so on), multiple processes (such as etching, sputtering, cleaning, and so on) are required to be performed for each kind of substrates. Each of the processes may be performed by a corresponding single machine. Owing to multiple processes, substrates must be taken and released and then transported from a process machine to the next process machine. When a substrate carrier of a process machine is used for a long time, terminals for carrying a substrate are prone to bend so that a height of each of the terminals is not identical. When a substrate, especially a glass substrate, is taken and released, forces that support the substrate everywhere are inconsistent so that the substrate is broken. The above problem not only affects product yield but also increases manufacturing costs.

Therefore, it is necessary to provide a method for detecting an abnormal terminal of a carrier in order to solve the above problem regarding a breakage of a substrate.

### SUMMARY

A technical problem is that, when a substrate carrier of a process machine is used for a long time, it is easy for terminals for carrying a substrate to bend so that a height of each of the terminals is not identical. When a substrate, especially a glass substrate, is taken and released, forces that support the substrate everywhere are inconsistent so that the substrate is broken. The above problem not only affects product yield but also increases manufacturing costs.

The object of the present disclosure is to provide a method for detecting an abnormal terminal of a carrier, which can detect an abnormal terminal of a carrier immediately and reduce probability of a breakage of a substrate.

In order to realize the above object, the present disclosure provides a method for detecting an abnormal terminal of a carrier having a plurality of annular areas with a plurality of terminals evenly arranged on the carrier and for carrying a substrate, the method including:

placing the substrate on the plurality of terminals of the carrier;

when the plurality of terminals carry the substrate, measuring force values taken by the plurality of terminals; and

comparing force values taken by the plurality of terminals in a same annular area to detect at least one abnormal terminal corresponding to each of the plurality of annular areas through the steps of:

determining at least two terminals with same force values as normal terminals; and

determining at least one terminal with a force value different from the same force values as the at least one abnormal terminal.

In order to realize the above object, the present disclosure provides a method for detecting an abnormal terminal of a carrier having a plurality of annular areas with a plurality of terminals for carrying a substrate, the method including:

placing the substrate on the plurality of terminals of the carrier;

when the plurality of terminals carry the substrate, measuring force values taken by the plurality of terminals; and

comparing force values taken by the plurality of terminals in a same annular area to detect at least one abnormal terminal corresponding to each of the plurality of annular areas.

In some embodiments, the step of comparing force values taken by the plurality of terminals in a same annular area includes:

determining at least two terminals with same force values as normal terminals; and

determining at least one terminal with a force value different from the same force values as the at least one abnormal terminal.

In some embodiments, the step of comparing force values taken by the plurality of terminals in a same annular area includes:

computing an average of the sum of the force values taken by the plurality of terminals;

and

comparing a difference between a force value taken by each of the plurality of terminals and the average to detect the at least one abnormal terminal.

In some embodiments, the plurality of terminals are evenly arranged on the carrier.

In some embodiments, the plurality of annular areas are arranged at an interval from each other and on the carrier.

In some embodiments, the each of the plurality of annular areas has a shape of a circle, a rectangle, or a triangle.

In some embodiments, the substrate is a glass substrate.

The beneficial effect of the present disclosure is that, an abnormal terminal of a carrier can be detected immediately, and probability of a breakage of a substrate is reduced.

### BRIEF DESCRIPTION OF DRAWINGS

To ensure the features and the technical content of the disclosure are more apparent and easier to understand, please refer to the explanation and the accompanying drawings of the disclosure as follows. However, the accompanying drawings are merely for reference without limiting the disclosure.

FIG. 1 is a top view of a carrier used in an embodiment of the present disclosure.

FIG. 2 is a flow chart of a method for detecting an abnormal terminal of a carrier according to an embodiment of the present disclosure.

FIG. 3 is a flow chart of step S03 in FIG. 2 according to an embodiment of the present disclosure.

FIG. 4 is a flow chart of step S03 in FIG. 2 according to another embodiment of the present disclosure.

FIG. 5 illustrates a distribution of forces taken by terminals of a carrier in normal circumstances according to an embodiment of the present disclosure.

FIG. 6 illustrates a distribution of forces taken by terminals of a carrier in abnormal circumstances according to an embodiment of the present disclosure.

### DETAILED DESCRIPTION OF EMBODIMENTS

To ensure the objects, the technical solutions, and the effects of the disclosure are clearer and more specific, the disclosure will be explained in conjunction with the accompanying drawings in detail further below. It should be understood that the embodiments described herein are merely a part of the embodiments of the present disclosure instead of all of the embodiments and not used to limit the disclosure.

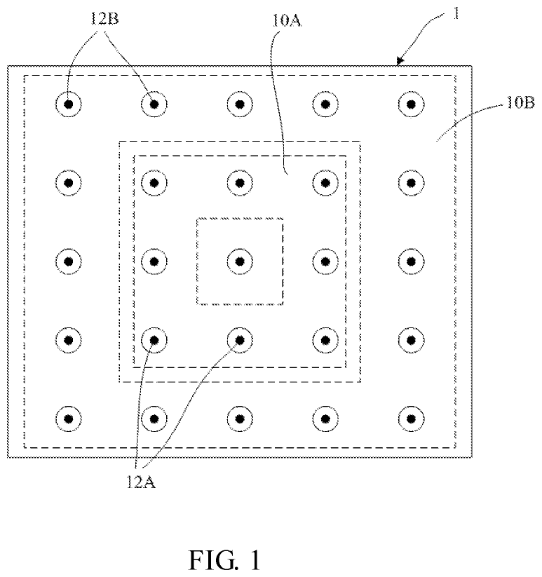

Please refer to FIG. 1, which is a top view of a carrier 1 used in an embodiment of the present disclosure. The carrier 1 includes a plurality of annular areas 10A and 10B. A plurality of terminals 12A and 12B for carrying a substrate (not shown) are disposed in the annular areas 10A and 10B respectively. In an embodiment of the present disclosure, the terminals 12A and 12B are evenly arranged on the carrier 1. The annular areas 10A and 10B are arranged outwardly at an interval from each other and on the carrier 1. Specifically, each of the annular areas 10A and 10B has, without limitation, a shape of a rectangle. Also, each of the annular areas 10A and 10B may have a shape of a circle, a triangle, or other types.

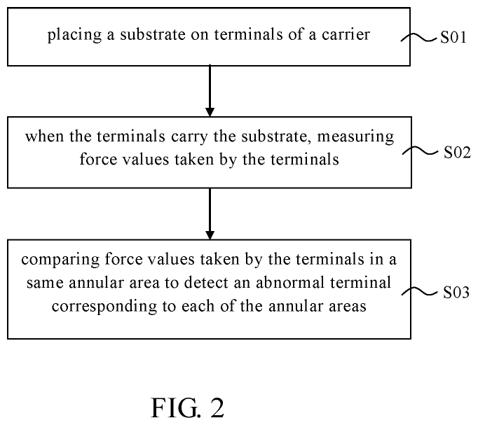

FIG. 2 is a flowchart of a method for detecting an abnormal terminal of a carrier according to an embodiment of the present disclosure. Also referring to FIG. 1, a method for detecting an abnormal terminal of a carrier 1, provided in the present disclosure, includes the following steps:

Step S01: placing a substrate on the plurality of terminals 12A and 12B of the carrier 1. In an embodiment of the present disclosure, the substrate can be, but not limited to, a glass substrate.

Step S02: when the plurality of terminals 12A and 12B carry the substrate, measuring force values taken by the plurality of terminals 12A and 12B.

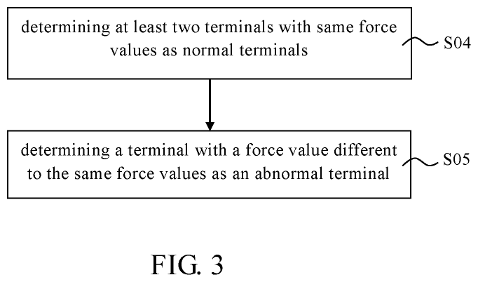

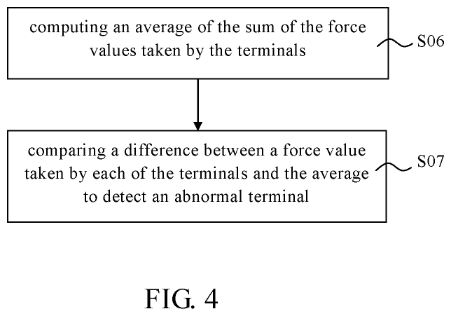

Step S03: comparing force values taken by the plurality of terminals 12A or 12B in a same annular area 10A or 10B. An abnormal terminal corresponding to each of the plurality of annular areas 10A and 10B can be detected based on a result of comparison. With regard to comparison methods of the step, please refer to the explanations of FIG. 3 and FIG. 4.

FIG. 3 is a flow chart of step S03 in FIG. 2 according to an embodiment of the present disclosure. Specifically, step S03 includes the following steps:

Step S04: determining at least two terminals 12A (or 12B) with same force values as normal terminals.

Step S05: determining a terminal 12A (or 12B) with a force value different from the same force values as the abnormal terminal.

In general, because abnormal terminals do not appear at the same time, through steps S04 and S05, an abnormal terminal can be found by detecting that a force value taken by some terminal is apparently different from the one taken by the majority of terminals.

FIG. 4 is a flow chart of step S03 in FIG. 2 according to another embodiment of the present disclosure. Specifically, step S03 includes the following steps:

Step S06: computing an average of the sum of the force values taken by the plurality of terminals 12A (or 12B).

Step S07: comparing a difference between a force value taken by each of the plurality of terminals 12A (or 12B) and the average to detect the abnormal terminal.

Owing to the greatest difference between a force value taken by an abnormal terminal and an average of the sum of the force values taken by all terminals, through steps S06 and S07, an abnormal terminal can be found by detecting that a difference between a force value taken by some terminal and the average is largest.

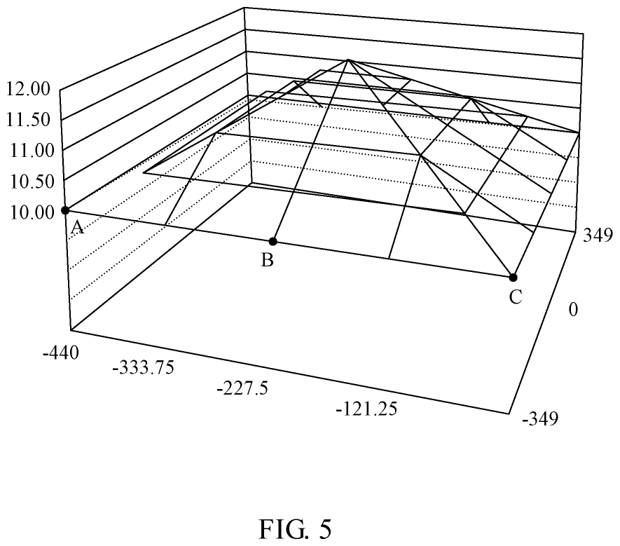

FIG. 5 illustrates a distribution of forces taken by terminals of a carrier in normal circumstances according to an embodiment of the present disclosure. Referring to FIG. 5 in combination with FIG. 1, suppose points A, B, and C represent force values taken by three terminals 12B in a same annular area 10B. As shown in this figure, all of points A, B, and C have force values of 10.00 force units so that a distribution of forces formed by points A, B, and C is even and symmetric. Further, no abnormal terminals in the annular area 10B are detected through performing a detecting method of the present disclosure.

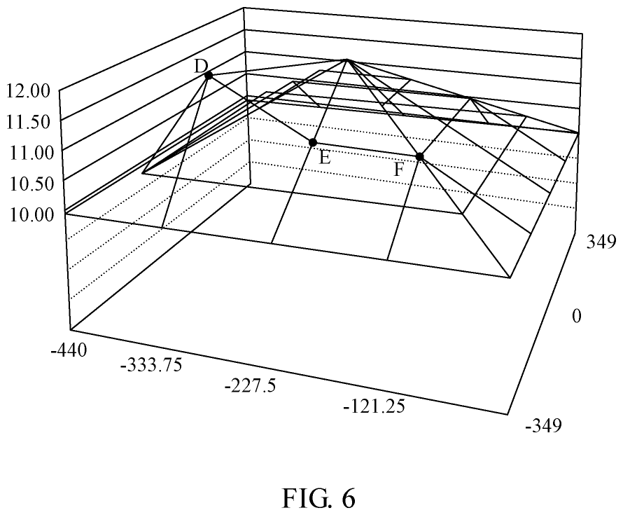

FIG. 6 illustrates a distribution of forces taken by terminals of a carrier in abnormal circumstances according to an embodiment of the present disclosure. Referring to FIG. 6 in combination with FIG. 1, suppose points D, E, and F represent force values taken by three terminals 12A in a same annular area 10A. As shown in this figure, both of points E and F have force values of 10.50 force units, but point D has a force value of 11.00 force units so that a distribution of forces formed by points D, E, and F is apparently asymmetric. Further, a terminal 12A that corresponds to point D can be detected as an abnormal terminal in the annular area 10A through performing a detecting method of the present disclosure.

In conclusion, the present disclosure provides a method for detecting an abnormal terminal of a carrier mainly by comparing force values taken by a plurality of terminals in a same annular area to detect an abnormal terminal of a carrier so that probability of a breakage of a substrate is reduced, and not only is product yield improved, but manufacturing costs are also reduced.

It should be understood that the application of the present disclosure is not limited by the foregoing examples. A person of ordinary skill in the art is able to make modifications or changes based on the foregoing description, and all of these modifications and changes are within the scope of the appended claims of the present disclosure.

The industrial applicability of the present disclosure is that, a method for detecting an abnormal terminal of a carrier can reduce probability of a breakage of a substrate and not only improve product yield but also reduce manufacturing costs.

What is claimed is:

1. A method for detecting an abnormal terminal of a carrier having a plurality of annular areas with a plurality of terminals evenly arranged on the carrier and for carrying a substrate, the method comprising:
placing the substrate on the plurality of terminals of the carrier;
when the plurality of terminals carry the substrate, measuring force values taken by the plurality of terminals; and
comparing force values taken by the plurality of terminals in a same annular area to detect at least one abnormal terminal corresponding to each of the plurality of annular areas through the steps of:
determining at least two terminals with same force values as normal terminals; and
determining at least one terminal with a force value different from the same force values as the at least one abnormal terminal.

2. A method for detecting an abnormal terminal of a carrier having a plurality of annular areas with a plurality of terminals for carrying a substrate, the method comprising:
placing the substrate on the plurality of terminals of the carrier;
when the plurality of terminals carry the substrate, measuring force values taken by the plurality of terminals; and
comparing the force values taken by the plurality of terminals in a same annular area to detect at least one abnormal terminal corresponding to each of the plurality of annular areas.

3. The method of claim 2, wherein the step of comparing the force values taken by the plurality of terminals in the same annular area comprises:
determining at least two terminals with same force values as normal terminals; and
determining at least one terminal with a force value different from the same force values as the at least one abnormal terminal.

4. The method of claim 2, wherein the step of comparing force values taken by the plurality of terminals in the same annular area comprises:
computing an average of the sum of the force values taken by the plurality of terminals; and
comparing a difference between a force value taken by each of the plurality of terminals and the average to detect the at least one abnormal terminal.

5. The method of claim 2, wherein the plurality of terminals are evenly arranged on the carrier.

6. The method of claim 2, wherein the plurality of annular areas are arranged at an interval from each other and on the carrier.

7. The method of claim 2, wherein the each of the plurality of annular areas has a shape of a circle, a rectangle, or a triangle.

8. The method of claim 2, wherein the substrate is a glass substrate.
